(19) United States
(12) Patent Application Publication
(10) Pub. No.: US 2005/0197156 A1
(43) Pub. Date: Sep. 8, 2005

(54) Method of selecting a communication network for a mobile communication terminal on the basis of information on wireless network access points

(75) Inventors: Xavier Fourquin, Sevres (FR); Emmanuel Seurre, Versailles (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/052,837

(22) Filed: Feb. 9, 2005

(30) Foreign Application Priority Data
Feb. 10, 2004 (FR) 04 50 229

(51) Int. Cl. H04M 1/00

(52) U.S. Cl. 455/553.1

(57) ABSTRACT

A method is dedicated to selecting a communication network for a dual mode mobile communication terminal. This method consists in the mobile terminal listening to a chosen signaling channel of its parent cellular communication network on which is transmitted, in a chosen mode, information data on access points to at least one wireless local area network, accessible in the cell in which the mobile terminal is situated, and in selecting one of the accessible access points as a function of at least one chosen selection criterion, so that the mobile terminal can communicate with a remote communication terminal via the selected access point, given the transmitted information data, if the latter is more suitable for the communication than the cellular network.

### CROSS-REFERENCE TO RELATED APPLICATIONS

This application is based on French Patent Application No. 04 50 229 filed Oct. 02, 2004, the disclosure of which is hereby incorporated by reference thereto in its entirety, and the priority of which is hereby claimed under 35 U.S.C. §119.

### BACKGROUND OF THE INVENTION

1. Field of the Invention

The invention concerns the field of communication networks and more precisely setting up communications between dual mode mobile communication terminals and remote other communication terminals.

2. Description of the Prior Art

The expression “dual mode mobile communication terminal” means any type of mobile terminal capable of exchanging data with a cellular communication network and with a wireless local area network (for example a WLAN). Consequently, this could be, for example a mobile telephone, a personal digital assistant (PDA), or a portable computer equipped with a radio communication interface, provided that it is also equipped with a network interface controller card or a wireless adapter operating, in the case of a WLAN, under any version of the Ethernet 802.11 standard.

In certain types of data communication, transmission may require high bit rates unavailable to a GSM/GPRS or UMTS mobile terminal via its parent cellular network, although it could be effected via a wireless local area network at least partly in the coverage area of said cellular network. Moreover, a mobile terminal may find it impossible to establish communication via its parent cellular network at a given time, because the latter is saturated, although communication could be effected via a wireless local area network at least partly in the coverage area of said cellular network.

A dual mode mobile terminal being able to operate only in cellular mode or in wireless local area (for example WLAN) mode, its user must therefore determine prior to each communication the type of network to which his terminal must connect, given the type of communication envisaged. Furthermore, a dual mode mobile terminal cannot switch from a network of a given type, for example a cellular network, to a network of another type, for example a WLAN, while it is communicating.

An object of the invention is therefore to remedy this drawback and in particular to enable selection of the type of network that is most suited to the instantaneous requirements of a dual mode terminal.

### SUMMARY OF THE INVENTION

To this end it proposes a method of selecting a communication network for a dual mode (cellular and wireless local area) mobile communication terminal, characterized in that it consists in the mobile terminal listening to a chosen signaling channel of its parent cellular communication network on which is transmitted, in a chosen mode, information data on access points to at least one wireless local area network, accessible in the cell in which the mobile terminal is situated, and in selecting one of the accessible access points as a function of at least one chosen selection criterion, so that the mobile terminal can communicate with a remote communication terminal via the selected access point, given the transmitted information data, if the latter is more suitable for the communication than the cellular network.

At least some of the information data is preferably transmitted periodically by the cellular network in broadcast mode.

For example, the information data for each access point accessible in a cell represents at least its identifier (and preferably its name).

In this case, selection may be effected from a list of at least one access point designated by its identifier. The information data representative of an access point identifier from the list may be associated with information data representative of at least one characteristic of the access point. For example, the characteristics are chosen in a group comprising at least the radio frequency type, the bit rate, the radio signal level, the proximity, the load level, the cost of communication, the relevant operator, and the authentication method to be used.

The list may be ordered as a function of at least one selection criterion applied to at least one chosen characteristic associated with the identifier of each access point from the list. An access point is then selected as a function of its position in the list. For example, the selection criterion may apply to the comparison of the current values of the chosen characteristic for the access points from the list.

The access point may instead be selected as a function of a comparison of the current values of at least one chosen characteristic for the access points from the list.

At least a portion of the selection may be effected by the mobile terminal on the basis of information data received from the cellular network. Accordingly, in the event of selection relating at least to the radio signal level, the mobile terminal, may, for example, effect signal transmission tests in respect of each access point from the list to determine the one that offers the highest radio signal level and select the latter.

However, selection may also be effected at least in part by the cellular network.

For example, certain characteristics may be chosen as a function of the type of communication that the mobile terminal wishes to establish. This is especially suitable for situations in which selection is effected by the mobile terminal.

At least a portion of the selection may be effected before establishing a communication, or during a communication via a cellular network or a wireless local area network, in such a manner as to switch to the wireless local area network or the cellular network. For example, in the event of switching from a cellular network to a wireless local area network, the communication established via the cellular network may be put on hold and, in the event of further switching from the wireless local area network to the cellular network, the communication initially established via the cellular network may be re-established and the communication via the wireless local area network is terminated.

Other features and advantages of the invention will become apparent on examining the following detailed description and the appended drawing.

### BRIEF DESCRIPTION OF THE DRAWING

FIG. 1 is a diagram of one example of a communication installation including a cellular communication network (RCC), a public data network (RPD) and three wireless local area networks (W1 to W3).

FIG. 2 is a diagram of one embodiment of a mobile telephone (UE) adapted to implement the invention.

### DETAILED DESCRIPTION OF THE PREFERRED EMBODIMENT

The appended drawings constitute part of the description of the invention as well as, if necessary, contributing to the definition of the invention.

An object of the invention is to allow the selection of a communication network for a mobile communication terminal.

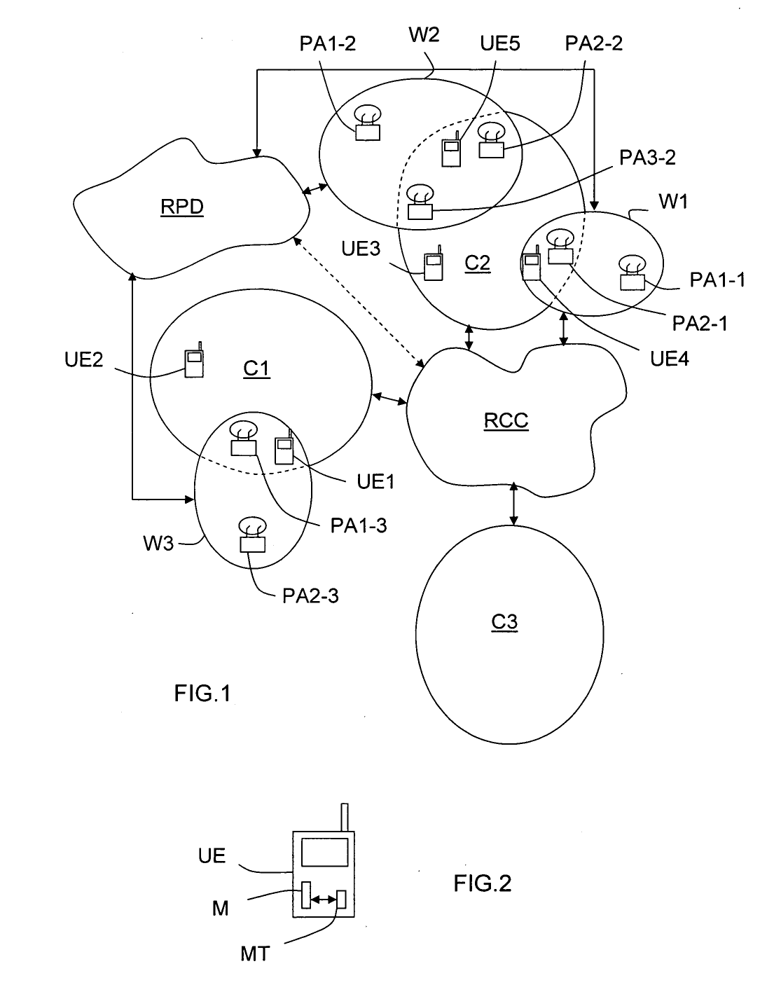

The communication installation shown in FIG. 1 by way of example includes at least one cellular communication network RCC, one public data network RPD and at least one wireless local area network Wi.

In this example of a communication installation, only one cellular network RCC is shown, but there could be several of them. This cellular network RCC belongs to a mobile telephone operator and has a radio coverage defined by a set of cells Cj (here j=1 to 3, but j can take any non-zero value). Moreover, this cellular network RCC may be connected to a public telephone network, for example a public switched telephone network (PSTN), and/or to one or more public land mobile networks (PLMN).

It is considered hereinafter that the cellular network RCC is a UMTS network. However, any other type of cellular network may be envisaged, and in particular GSM, GSM/GPRS and EDGE networks. UMTS networks being well known to the person skilled in the art, they will not be described in detail. Suffice to say that, broadly speaking, a UMTS network may be summarily described as a core network coupled to a radio access network (UTRAN). The radio access network includes one or more base stations known as Node Bs connected to the core network by one or more nodes known as radio network controllers (RNCs). Each Node B is associated with at least one cell Cj covering a radio area that may contain one or more mobile communication terminals UE. Moreover, each Node B is responsible for processing the signal and in particular for managing requests to access the UMTS network from communication terminals UE in the cell Cj that it controls.

Moreover, it is considered hereinafter that the public data network PDR is the Internet.

Also, three wireless local area networks Wi are shown (i=1 to 3), but there could be more of them, or fewer of them, provided that the installation includes at least one of them. These wireless local area networks Wi may belong to a single business, for example the operator of the cellular network RCC, or to a group of businesses associated with the same entity, or different businesses. It is considered hereinafter that the wireless local area networks Wi are WLAN conforming to the standardized 802.11x technology. They could be of some other type, however, for example Bluetooth or UWB (Ultra Wide Band).

Each wireless local area network Wi conventionally has one or more access points PAk-i, also known as “WiFi hotspots”, allowing dual mode mobile communication terminals UE to connect to it.

Here the expression “dual mode mobile communication terminal” means any type of mobile terminal capable of exchanging data with a cellular communication network RCC and a wireless local area network Wi. It will be considered hereinafter, by way of example, that the dual mode mobile terminals are mobile (or cellular) telephones equipped with an access network card (or network interface controller) or a wireless adapter conforming to the version of the Ethernet 802.11 standard used by the wireless local area networks Wi. However, they could also be personal digital assistants (PDAs) or portable computers equipped with a cellular radio communication interface with a cellular communication network RCC and an access network card or wireless adapter conforming to the Ethernet 802.11 standard allowing access to a local area network LAN and/or to the Internet. The expression “communication module (MC)” used hereinafter refers to the hardware and/or software elements of the mobile terminal UE responsible for communication with the cellular network RCC, to be more precise its Node Bs, and with the wireless local area networks Wi, to be more precise their access points PA.

In the example shown, each wireless local area network Wi is connected to the Internet RPD, but this is not obligatory. Although this is not shown, this connection is effected conventionally by way of an edge router providing the call server function.

Moreover, in the example shown, only the wireless local area network W1 is connected to the cellular network RCC, for example because it belongs to its operator, or because their respective operators have entered into agreements. However, this is not obligatory. The wireless local area network W1 is also connected to the cellular network RCC via the edge router, which in this case is responsible for establishing the connections between dual mode mobile terminals UE in the coverage area of the wireless local area network Wi, and are therefore able to connect by radio to the access points PA to which it is coupled, and the cellular network RCC and the data network RPD.

It is important to note that an edge router (or call server) may be installed in the (or a) controller of access points PA of the wireless local area network Wi. This is particularly advantageous because the controller of access points PA has access to the data network RPD, for example ADSL access to the public Internet, and/or to the cellular network RCC, via a cable, preferably an Ethernet cable, or by radio, for example by an 802.11 b radio link. With a configuration of this kind, a cellular network RCC operator may offer its customers very high bit rate extensions for end-to-end services such as digital television, video on demand, broadcasting and voice over Internet protocol (VoIP), for example.

In order for a mobile telephone UE to be able to benefit at all times from the communication network best suited to its requirements, for example in terms of network resources or communication cost, the invention proposes to transmit on a chosen signaling channel of its parent cellular network RCC, in a chosen mode, information data on access points PAk-i to a wireless local area network Wi accessible in the cell Cj in which it is situated.

Accordingly, when the mobile telephone UE listens to this signaling channel, it has access to information enabling it, if it so wishes, to communicate with a remote communication terminal via an access point PAk-i selected as a function of at least one chosen selection criterion.

As will emerge hereinafter, an access point PAk-i may be selected at the level of the cellular network RCC and/or at the level of the mobile telephone UE.

In the example shown, there is a partial radio overlap on the one hand between the cell C1 and the wireless local area network W3 and on the other hand between the cell C2 and the wireless local area networks Wi and W2. To be more precise, the access point PA1-3 of the network W3 is in the coverage area of the cell C1, the access point PA2-1 of the network W1 is in the coverage area of the cell C2, and the access points PA2-2 and PA3-2 of the network W2 are in the coverage area of the cell C2.

Consequently, the access point PA1-3 is accessible to the mobile telephone UE1 that is both in its coverage area and in that of the cell C1, the access point PA2-1 is accessible to the mobile telephone UE4 that is both in its coverage area and in that of the cell C2 and the access points PA2-2 and PA3-2 are accessible to the mobile telephone UE5 that is both in their coverage areas and in that of the cell C2.

On the other hand, in this example, the mobile telephones UE2 and UE3 that are in the coverage areas of the cells C1 and C2, respectively, but outside the coverage areas of the networks W3 and W2 are temporarily unable to benefit from the network selection facility offered by the invention. The same would apply to any mobile telephone UE anywhere in the coverage area of the cell C3, because the latter does not overlap anywhere the coverage area of a wireless local area network.

There are at least two selection modes.

A first mode consists in transmitting to the mobile telephones UE situated in a cell Cj only information data representative of the identifier (and preferably the name) of each access point PAk-i accessible in said cell Cj. In this case, each mobile telephone UE has an internal memory for storing a table of the correspondences between identifiers of access points PAk-i and one or more associated characteristics, for example their radio frequency type (for example 11a, 11b, 11g, . . . ), their capacity in terms of resource, their communication cost, the operator to which they belong, and the authentication method to be used in the wireless local area network Wi.

Two situations may then be envisaged, according to whether the information data takes the form of an ordered list or a non-ordered list.

In the case of an ordered list, the various access points PAk-i accessible in a cell Cj (which may belong to different wireless local area networks Wi) are classified as a function of at least one chosen selection criterion. The mobile telephone UE that wishes to establish communication via an access point PA from the list extracts from its memory the characteristics of the access point PA at the top of the list and then attempts to establish a radio connection with it (it is assumed here that the mobile telephone is obliged to respect the order of the list). If it is not in the overlap area of its cell and the access points, it is unable to establish this connection, and it therefore attempts to establish a radio connection with the access point PA that is second in the list. If the connection is set up, if its radio level is sufficient, and if the access point has sufficient available resources, the communication is established. Otherwise, the mobile telephone UE attempts to establish a radio connection with the access point PA that is third in the list, and so on. If no connection can be established with an access point from the list, then communication is only possible via the parent cellular network RCC of the mobile telephone UE, provided that its capacities allow this.

Of course, in some situations, a list may comprise only one access point identifier.

The ordered list is transmitted to the mobile telephones UE by their parent cellular network RCC. It may be determined either within the core network or within the radio access network, for example at the level of the RNCs (although it is equally possible at the level of the Nodes B).

This ordering is effected as a function of at least one chosen selection criterion. The main selection criteria include the bit rate, the radio signal level, the proximity, the charge level, the cost of communication, and the relevant operator. For example, the operator of the cellular network RCC may offer only the access points PAk-i of a wireless local area network Wi that belongs to it or with whose operator it has an agreement for use, and classify the accessible access points as a function of their load level. Certain selection criteria depending on the current values of characteristics that depend on measurements effected by the mobile telephones or by the radio access network, it is therefore advantageous if at least a portion of the selection process is effected at the level of said radio access network. The operator of the cellular network RCC can therefore exploit, optimize and customize its service offers, in particular by controlling the evolution of its installed base of access points PA (or hotspots) and the updating of the various lists of access points.

In the case of a non-ordered list, the mobile telephone UE that wishes to establish communication via an access point PA from the list must effect its own selection within that list. To this end, it must compare with each other the current values of at least one of the characteristics of the access points PA from the list, which are stored in the correspondence table, as a function of a chosen selection criterion, for example as a function of the required communication type. The main selection criteria include the bit rate, the radio signal level, the proximity, the load level, the cost of the communication, and the relevant operator. For example, the mobile telephone UE may require simultaneously the highest possible bit rate and the best radio signal level.

The current values of the characteristics of the access points PA are broadcast periodically by the Nodes B of the cellular network RCC on the signaling channel, for example, so that they can be regularly refreshed.

Once the mobile telephone UE has ordered the access points PA from the list as a function of its selection criterion or criteria, it extracts from its memory the characteristics of the access point PA at the top of the list and then attempts to establish a radio connection with it (it is assumed here that the mobile telephone is obliged to respect the order of the list). If it is not in the area of overlap of its cell Cj and the access point PA, it is unable to establish this connection, and it therefore attempts to establish a radio connection with the access point PA that is second in the list that it has ordered. If the connection is established, then communication may be established (provided that sufficient resources are available). If the connection cannot be established, the mobile telephone UE attempts to establish a radio connection with the access point PA that is third in the list that it has ordered, and so on. If no connection can be established with an access point PA from the list, then communication can be effected only via the parent cellular network of the mobile telephone UE, again provided that its capacities allow this.

Alternatively, once it has ordered the access points PA from the list, the mobile telephone UE may effect signal transmission tests with respect to each of them in order to determine those that it is actually able to contact, and possibly the radio signal level that they are offering. The classification can then be modified as a function of these tests, for example so as to give preference to, and thus to select, the access point PA that offers the highest radio signal level for substantially equal chosen characteristic values.

A second mode consists in transmitting to the mobile telephones UE in a cell Cj information data representative of the identifier (and preferably the name) of each access point PAk-i accessible in said cell Cj and of at least one of the associated characteristics, for example the radio frequency type, the bit rate, the load level (resources available), the proximity, the cost, the relevant operator, and the authentication method to be employed in the wireless local area network Wi.

The access points PA from the list transmitted may be classified as a function of a criterion specific to the operator or to each cell Cj. Consequently, the situation is again that of the first mode, described hereinabove, in which the list could be ordered or not. What distinguishes these two modes is simply the fact that in the second mode the information data representative of the characteristic(s) is transmitted at the same time as the identifiers of the access points PA and not stored in a memory.

Of course, a mixed mode of operation may be envisaged in which the mobile telephones UE store in a memory certain “static” characteristics of the access points PA and receive “dynamic” characteristics of the access points PA on the signaling channel of their parent cellular network RCC. Here the term “static characteristic” means a characteristic that does not vary quickly in time, for example the bit rate, the proximity, the cost, the authentication method or the relevant operator, and the term “dynamic characteristic” means a characteristic that may vary quickly in time, for example the radio signal level or the load level.

It is important to note that it is not an objective of the invention necessarily to select an access point PAk-i to a wireless local area network Wi. The main objective of the invention is in fact to determine the communication network that is the best suited to the immediate requirements of a mobile telephone UE, and if this is a wireless local area network Wi, the access point PAk-i that is deemed to be the best suited to said immediate requirements. Thus a mobile telephone UE may be configured by its user or by its parent cellular network RCC so as always to give preference to the cost of the communication and/or the bit rate and/or the radio signal level. Consequently, selection may lead to establishing communication with the parent cellular network RCC and not with an access point PAk-i.

Moreover, it is equally important to note that the invention enables an access point PA to be selected either before establishing a communication or during a communication via a cellular network RCC or via a wireless local area network Wi.

In fact, in certain situations, for example during communication with a remote terminal, a user may need to access the Internet to obtain information, although the network through which he has established the first communication does not allow this, or to transmit data, for example video data, although the network through which he established the first communication does not allow this or momentarily does not have sufficient resources available, or to switch to the network that offers the lowest communication cost.

In such situations, according to the invention, a mobile telephone UE is adapted to determine, in parallel with the established communication, the communication network that is best suited to its immediate requirements and to which it can connect.

The switching may be “definitive”, for example if the user no longer requires to re-establish communication with the original remote terminal or requires to transmit data necessitating a high bit rate to the original remote terminal whilst continuing its conversation. However, it may equally be temporary, for example if the user requires to obtain information from another remote terminal or from a data server, to continue its original conversation with the user of the original remote terminal.

If a mobile telephone UE wishes to switch temporarily from its parent cellular network RCC to a wireless local area network Wi, it preferably addresses a hold request to a dedicated server of said cellular network RCC and then switches to the wireless local area network Wi via its selected access point PA, where applicable after requesting authorization from its user. Once it has obtained information via the wireless local area network Wi, it can then switch back to its parent cellular network RCC in order to resume the original conversation.

On the other hand, in the case of definitive switching, it is not necessary to alert the parent cellular network RCC since the switching automatically terminates the original communication.

It is of course equally possible to switch from a wireless local area network Wi to a cellular network RCC.

Selection may be refined with the aid of complementary messages provided by the cellular network RCC. In fact, in the environments in which the cellular network RCC can determine the position of the mobile terminal UE to within a few tens of meters and a wireless local area network Wi comprising a wide network of access points PA (“wide hotspot”) can find itself at least partially in a coverage area of the cellular network RCC, said cellular network RCC can transmit one or more specific signaling messages to the mobile terminal (UE) to inform it of the access point or points that are the closest, for example, or that belong to the operator.

In other words, the information contained in the complementary messages may be used either to modify the order of a list previously transmitted to the mobile terminal UE or to facilitate selection at the level of the mobile terminal UE, for example by avoiding it having to carry out tests on the radio signal levels offered by the access points PA around it.

It may additionally be envisaged that these messages contain information dedicated to the user of the mobile terminal UE, for example a password (or “login”), keys, etc.

As shown in FIG. 2, in order to implement the invention, each mobile terminal UE must be equipped with a processing module MT coupled to its communication module MC. The disposition of the processing module MT depends on the function that it provides and more precisely on whether it is itself responsible or not for selecting the communication network best suited to its immediate requirements, even if only partially. However, regardless of the envisaged mode of operation, the processing module MT is responsible for sending instructions to the communication module MC in order for it to establish communication with the selected network (selected access point PA or Node B).

The processing module MT may either be preconfigured or configurable by the cellular network RCC and/or by its user to enable the choice of at least one of the selection criteria and/or operation with or without authorization by its user, in particular with regard to switching networks if the selection criterion or criteria is or are satisfied.

Moreover, to enable implementation of the invention, the cellular network RCC must include one or more network equipments, for example RNCs or Nodes B, provided with a management module MG whose disposition depends on the function provided, to be more precise on whether it is responsible for determining the information data representative of the access points PAk-i accessible in each of its cells Cj and/or for some or all of the selection process.

The processing modules MT and the management module(s) MG of the invention may be implemented in the form of electronic circuits, software (or data processing) modules, or a combination of circuits and software.

The invention is not limited to the embodiments of a mobile communication terminal and a communication network selection method described hereinabove by way of example only, and encompasses all variants that the person skilled in the art might envisage that fall within the scope of the following claims.

1. A method of selecting a communication network for a dual mode mobile communication terminal, characterized in that it comprises said mobile terminal listening to a chosen signaling channel of its parent cellular communication network on which is transmitted, in a chosen mode, information data on access points to at least one wireless local area network, accessible in the cell in which said mobile terminal is situated, and selecting one of said accessible access points as a function of at least one chosen selection criterion, so that said mobile terminal can communicate with a remote communication terminal via said selected access point, given said transmitted information data, if the latter is more suitable for said communication than said cellular network.

2. The method claimed in claim 1, characterized in that at least some of the information data is transmitted periodically by said cellular network in broadcast mode.

3. The method claimed in claim 1, characterized in that said information data for each access point accessible in a cell represents at least one access point identifier.

4. The method claimed in claim 3, characterized in that selection is effected from a list of at least one access point designated by its identifier.

5. The method claimed in claim 4, characterized in that said information data representative of an access point identifier from said list is associated with information data representative of at least one characteristic of said access point.

6. The method claimed in claim 5, characterized in that said characteristics are chosen from a group consisting of the radio frequency type, the bit rate, the radio signal level, the proximity, the load level, the cost of communication, the parent operator, and the authentication method to be used.

7. The method claimed in claim 5, characterized in that said list is ordered as a function of at least one selection criterion applied to at least one chosen characteristic associated with the identifier of each access point from the list, said access point then being selected as a function of its position in said list.

8. The method claimed in claim 7, characterized in that said selection criterion applies to the comparison of the current values of the chosen characteristic for the access points from the list.

9. The method claimed in claim 5, characterized in that said access point is selected as a function of a comparison of the current values of at least one chosen characteristic for said access points from said list.

10. The method claimed in claim 1, characterized in that at least a portion of said selection is effected by said mobile terminal on the basis of information data received from said cellular network.

11. The method claimed in claim 6 characterized in that at least a portion of said selection is effected by said mobile terminal on the basis of information data received from said cellular network, and further characterized in that in the event of selection relating at least to said radio signal level, said mobile terminal effects signal transmission tests in respect of each access point from said list to determine the one that offers the highest radio signal level.

12. The method claimed in claim 1, characterized in that said selection is effected by said cellular network.

13. The method claimed in claim 7, characterized in that said characteristic is chosen as a function of the type of communication that said mobile terminal wishes to establish.

14. The method claimed in claim 1, characterized in that at least a portion of said selection is effected before establishing a communication.

15. The method claimed in claim 1, characterized in that at least a portion of said selection is effected during a communication via a cellular network, respectively a wireless local area network, in such a manner as to switch to a wireless local area network, respectively a cellular network.

16. The method claimed in claim 15, characterized in that in the event of switching from a cellular network to a wireless local area network, the communication established via said cellular network is put on hold.

17. The method claimed in claim 16, characterized in that in the event of further switching from said wireless local area network to said cellular network, the communication initially established via said cellular network is re-established and the communication via said wireless local area network is terminated.
